(19) United States
(12) Patent Application Publication
(10) Pub. No.: US 2020/0027583 A1
(43) Pub. Date: Jan. 23, 2020

(54) ANNULAR METAL NUCLEAR FUEL AND METHODS OF MANUFACTURING THE SAME

(71) Applicant: TerraPower, LLC, Bellevue, WA (US)

(72) Inventors: Joon Hyung Choi, Lexington, SC (US); Micah J. Hackett, San Francisco, CA (US); Pavel Hejzlar, Kirkland, WA (US); Ryan N. Latta, Bellevue, WA (US); James M. Vollmer, Kirkland, WA (US)

(73) Assignee: TerraPower, LLC, Bellevue, WA (US)

(21) Appl. No.: 16/229,359

(22) Filed: Dec. 21, 2018

Related U.S. Application Data
(60) Provisional application No. 62/609,831, filed on Dec. 22, 2017.

(51) Int. Cl. G21C 3/322; G21C 1/02; G21C 3/07; G21C 3/328; G21C 3/60; G21C 15/14; G21C 21/04; G21C 21/10

(52) U.S. Cl. CPC G21C 3/322; G21C 1/028; G21C 3/07; G21C 21/10; G21C 3/60; G21C 15/14; G21C 21/04; G21C 3/328

(57) ABSTRACT

Annular metal fuel and fuel rods are described that have improved performance over uranium oxide fuel rods. The annular metal fuel can be made out of porous metal nuclear fuel and will generate more power and operate at a much lower temperature than uranium oxide fuel. The annular metal fuel rods may be used in traveling wave reactors and other fast reactors. Pressurized water reactors may also be retrofit with annular metal fuel rods to improve reactor performance.

### CROSS REFERENCE TO RELATED APPLICATIONS

The present application claims the benefit of priority to U.S. Provisional Patent Application No. 62/609,831, titled “Annular Metal Nuclear Fuel and Methods of Manufacturing the Same”, filed Dec. 22, 2017, which application is hereby incorporated by reference herein.

### INTRODUCTION

One measure of performance of nuclear fuel rods is the ability of heat generated in the fuel to be transferred to the primary coolant through the cladding of the fuel rod. A proposed improvement to uranium oxide nuclear fuel rods, allowing higher heat transfer and thus higher reactor power from the same core volume, was the inclusion of a central void region with additional cladding running the length of the fuel rod. Coolant passed through this region as well as over the exterior of the fuel rod, increasing the total surface area over which coolant flowed and heat could be transferred.

However, actual performance of this annular design was inhibited by several factors. First, the uranium oxide fuels tended to expand at operational temperatures resulting in the fuel separating from the inner cladding and reducing the thermal conductivity between the inner cladding and the fuel. Second, the fission reaction caused the uranium oxide fuel to swell due to the generation of fission products within the fuel. As a result, either use of sufficiently strong claddings to hold the pressure created by the swelling of hard uranium oxide fuel or provision of an expansion space between the cladding and the fuel in anticipation of the swelling was required. Both of these compromises have a detrimental effect on the overall thermal conductivity between the fuel and the exterior of the cladding. Third, low density uranium dioxide fuel requires relatively high enrichment to accommodate power increases without reduction of cycle length and additional parasitic neutron absorption in the second cladding. Finally, uranium dioxide fuel operates at a relatively high temperature which poses additional design challenges.

Another measure of performance of nuclear fuel rod designs is related to accident tolerance. Many traditional fuel designs have been proven to operate well under normal plant operating conditions but have not performed well under severe-accident scenarios. This can lead to the destruction of the fuel cladding and the release of fission products in the event of a beyond-design-basis condition, such as that which occurred in both the Three Mile Island and Fukushima accidents.

### Annular Metal Nuclear Fuel and Methods of Manufacturing the Same

Annular metal fuel and fuel rods are described below that have improved performance over uranium oxide fuel rods. The annular metal fuel can be made out of porous metal nuclear fuel and will generate more power and operate at a much lower temperature than uranium oxide fuel. The annular metal fuel rods may be used in any fast spectrum reactor including, for example, traveling wave reactors. Pressurized water reactors (PWRs) may also be retrofitted with annular metal fuel rods to improve reactor performance. The metal fuel may be one or more annuli of solid fuel, referred to as annular slugs, or may be in the form of fuel particles or fuel powder packed into the annular region defined by the inner cladding and outer cladding. The metal fuel may be initially porous or may become porous as a result of irradiation. As annular metal fuels offer greater uranium density than is possible using typical uranium oxide (e.g., UO₂) fuels, the power generation of existing reactors may be increased with little or no modification of the existing equipment. This is primarily enabled due to the additional heat transfer surface of the inner cladding. In addition, the increased uranium loading of the metallic fuel potentially enables increased cycle lengths or burnup. For example, in an embodiment the annular metal fuels are estimated to allow up to a 50% power increase in a PWR compared to a traditional oxide fuel in the same core volume.

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIGS. 1A and 1B are cross-sectional views along orthogonal axes of an embodiment of an annular nuclear fuel rod of porous metal fuel.

FIG. 2 illustrates other configurations, different from the annular configuration of FIGS. 1A and 1B, which could also be used for fuel rods.

FIG. 3 is an exploded view of a fuel assembly for use in a traveling wave reactor.

FIG. 4 illustrates a portion of an embodiment of a fuel rod of multiple segments including a connecting segment that allows for flow between the central region and the exterior of the fuel rod.

FIG. 5 illustrates the intermediate components of the dual intermediate component manufacture method described above.

FIG. 6 illustrating a cross section of a portion of an annular space between the claddings showing the fuel and holddown device.

FIG. 7 illustrates a side view of a fuel assembly for use in a pressurized water reactor.

FIG. 8 illustrates an embodiment of a method of manufacturing an annular nuclear fuel rod.

### DETAILED DESCRIPTION

Before the annular metal fuel rods, which may alternatively be referred to as fuel pins, and construction methods are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments of the annular metal fuel only and is not intended to be limiting. It must be noted that, as used in this specification, the singular forms “a,” “an,” and “the” include plural referents unless the context clearly dictates otherwise. Thus, for example, reference to “a lithium hydroxide” is not to be taken quantitatively or as source limiting, reference to “a step” may include multiple steps, reference to “producing” or “products” of a reaction should not be taken to be all of the products of a reaction, and reference to “reacting” may include reference to one or more of such reaction steps. As such, the step of reacting can include multiple or repeated reactions of similar materials to produce identified reaction products.

### Annular Metal Fuel Rods

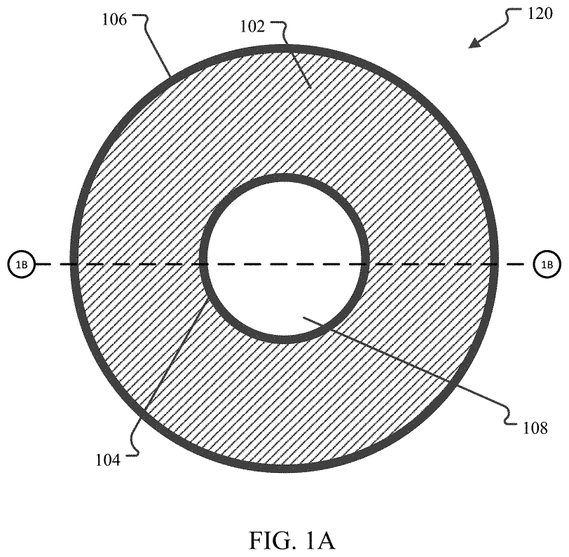

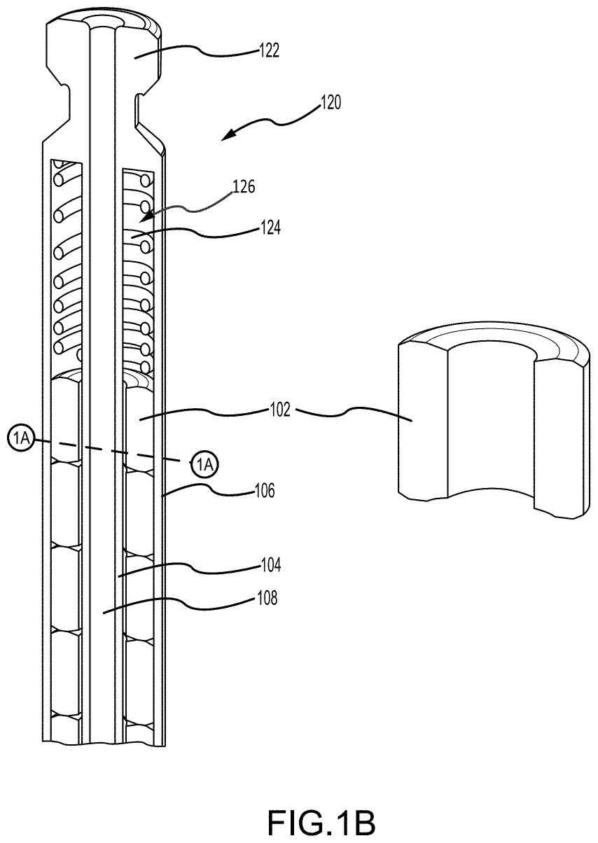

FIGS. 1A and 1B are cross-sectional views along orthogonal axes of an embodiment of an annular nuclear fuel rod of porous metal fuel. FIG. 1A is a cross-sectional view through the plane orthogonal to the long axis of the rod 120 and FIG. 1B is a cross-sectional view through the long axis of the rod 120. The fuel rod 120 has an annulus, or tube, of porous metal fuel 102 bounded on the interior surface by an inner cladding 104 and on the exterior surface with an outer cladding 106. As discussed in greater detail below, the metal fuel may be one or more annuli of solid fuel, referred to as annular slugs, or may be in the form of fuel particles or fuel powder packed into the annular region defined by the inner cladding 104 and outer cladding 106. The metal fuel 102 may be initially porous or may become porous as a result of irradiation during use in a nuclear reactor.

The central void region 108 of the annular fuel rod, which may also be referred to as a central coolant channel, is an inner channel through the fuel slugs 102. This central region 108 provides a coolant flow path and contact surface (with the inner cladding 104) through the center of the rod 120. The central region 108 may be co-axial with the long axis of the fuel rod (as shown) or may be offset.

As shown in FIG. 1B, the fuel rod 120 may be capped on one or both ends of the fuel rod by an end cap 122 as is known in conventional fuel rods. A plenum 126 containing a plenum spring 124 may also be provided at one or both ends of the fuel rod 120 to apply a bias force against the fuel and ensure the proper placement of the annular fuel slugs 102 within the main section of the rod 120. Clips are an alternative form of biasing element that may be used instead of or in combination with one or more plenum springs to hold the fuel column in place. The plenum spring 124 may be in direct contact with the fuel slugs 102 or a washer or other intermediate structure (not shown) may be between the plenum spring 124 and the fuel 102 to distribute the applied force more evenly to the fuel. In an embodiment, the plenum 126 and plenum spring 124 may be part of the end cap 122. In an alternative embodiment, a plenum 126 is simply the space between the fuel slugs 102 and the beginning of the end cap 122.

In the embodiment shown, the central region 108 extends for the entire length of the fuel rod 120 including the end caps 122. In an alternative embodiment, a manifold type arrangement may be provided in one or both end caps 122 or in the plenum(s) 126 so the central region 108 extends only through annular fuel slugs 102 and some or all of the plenum(s) 126.

Fuel rods 120 may be made to meet the form factor and design requirements for existing nuclear pressurized water reactor (PWR) designs. This allows existing reactor designs to be retrofitted with fuel rods containing annular metal fuels. As annular metal fuels offer greater uranium density than is possible using typical uranium oxide (e.g., UO₂) fuels, the power generation of existing reactors may be increased with little or no modification of the existing equipment. This is primarily enabled due to the additional heat transfer surface of the inner cladding. In addition, the increased uranium loading of the metallic fuel potentially enables increased cycle lengths or burnup. For example, in an embodiment the annular metal fuels are estimated to allow up to a 50% power increase in a PWR compared to a traditional oxide fuel in the same core volume.

Yet another benefit is that the annular metal fuel rods may be heated up more quickly than traditional UO₂ fuel rods without risking damage to the fuel matrix and cladding. UO₂ fuels can shatter due to differential thermal stress on the fuel if heated too quickly and fuel-cladding mechanical interaction from the hard UO₂ pellets can lead to cladding damage. This limits the speed at which traditional UO₂ equipped nuclear reactors can be brought up to full power and, thus, limits such reactors' use as load following power plants that must adjust power output in response to electricity demand. Annular metal fuel rods, as described herein, may be heated up much more quickly than UO₂ fuel rods (for example, it is estimated that uranium-zirconium fuel rods may be heated up at approximately 6 times the rate of UO₂ fuel rods). This allows existing reactors retrofitted with annular metal fuel rods to be more effectively used as load following power plants.

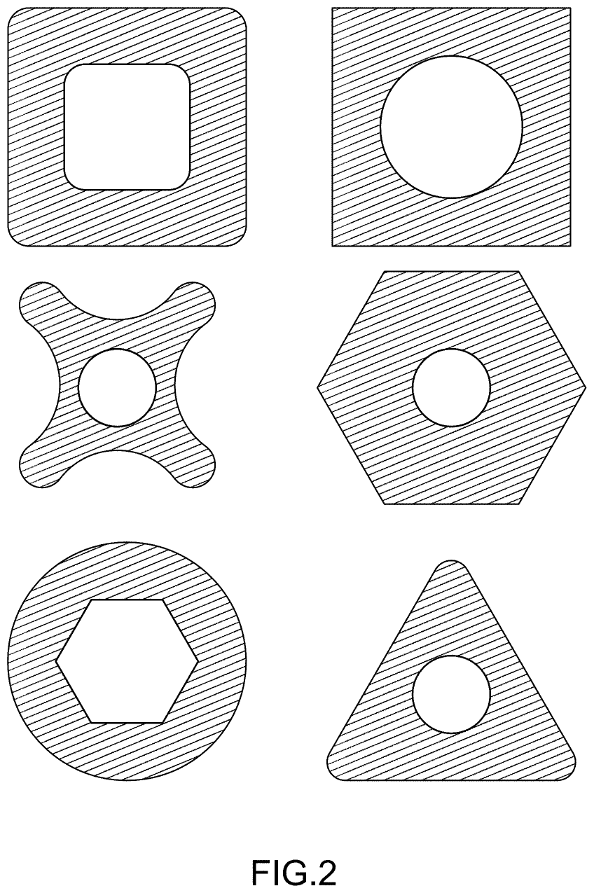

FIG. 2 illustrates other configurations, different from the annular configuration of FIG. 1, which could also be used for fuel rods 120 and/or for annular fuel slugs 102 within fuel rods. Any shape may be used for either cladding. The cross-sectional shapes may be regular polygons such as triangles, squares, hexagons, octagons, etc. Corners may be more or less rounded and the cross-section may be any lobed-shape such as the four-lobed rod shown.

As illustrated, the cross-sectional shape of the exterior of the fuel rod and the inner region may be the same or different. In an embodiment, the rod configuration can maintain control rod and guide thimble tubes.

In addition, non-cylindrical fuel rods may be provided with a helical twist along their length on either the interior surface or the exterior surface, or both. For example, the design could also involve rifling the inner surface of the inner cladding or exterior surface for better heat transfer and optimization of flow distribution between the inner cladding and outer cladding. Alternatively, the exterior surface of the rods could be provided with a helical wire wrap (not shown) and/or a rigid helical structure could be attached to either or both of the exterior or interior surfaces.

Thin liners (not shown) between claddings and fuel can be also used, if needed, to prevent fuel cladding chemical interaction and in the case of cladding breach, can be expected to reduce the reaction of metal fuel with water coolant.

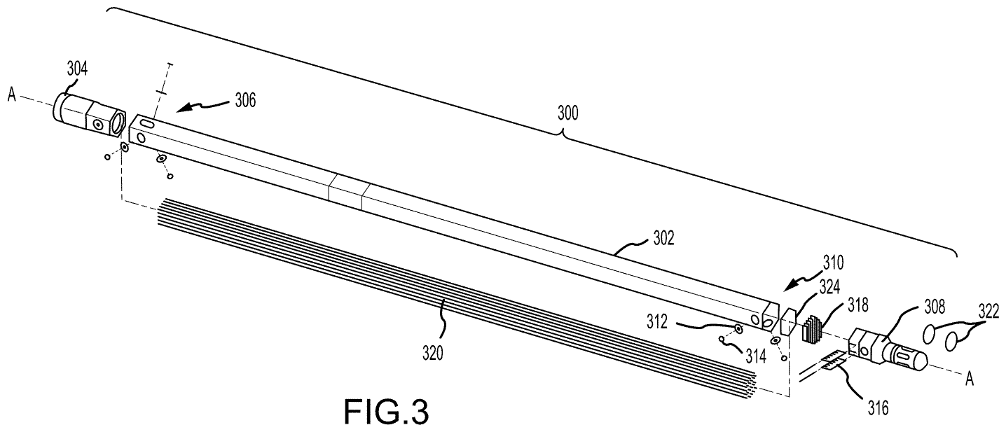

FIG. 3 is an exploded view of a fuel assembly 300 for use in a traveling wave reactor or other sodium cooled fast reactor. The assembly 300 includes an elongated coolant channel 302 having an axis A. The channel 302 has a hexagonal cross section. A handling socket 304 with an internal flow passage is secured to a first end 306 of the channel 302 and has internal or external features that allow it to be grasped by mechanisms within the reactor vessel to lift, lower, and otherwise move the assembly 300 into, out of, or within the core. An inlet nozzle 308 is secured to a second end 310 of the channel 302. A plurality of bearing rings 312 and retaining rings 314 are used to attach the handling socket 304 and inlet nozzle 308 to the channel 302. A plurality of lock plates 316 (two in this example) and a plurality of rod strip rails 318 are included proximate an end of the inlet nozzle 308. Together, the lock plates 316 and rod strip rails 318 connect the fuel rod bundle 320 to the inlet nozzle 308. In an embodiment, all of the fuel rods in the fuel rod bundle 320 are annular metal fuel rods as described above. In an alternative embodiment, only some of the fuel rods may be annular metal fuel rods with the other rods being of a different type or construction. Seal rings 322 and a flow restrictor 324 are also depicted.

Annular metal fuel rods may be a unitary construction as shown in FIG. 1. Alternatively, annular metal fuel rods may be made up of multiple segments bonded, screwed, or otherwise connected together to create the desired length. This allows fuel rods to be constructed to any length and a certain modularity and flexibility in construction of individual rods. Fuel rod segments could include fuel-containing segments, end cap segments (which may or may not include plenums and plenum springs, separate plenum segments, and other segments).

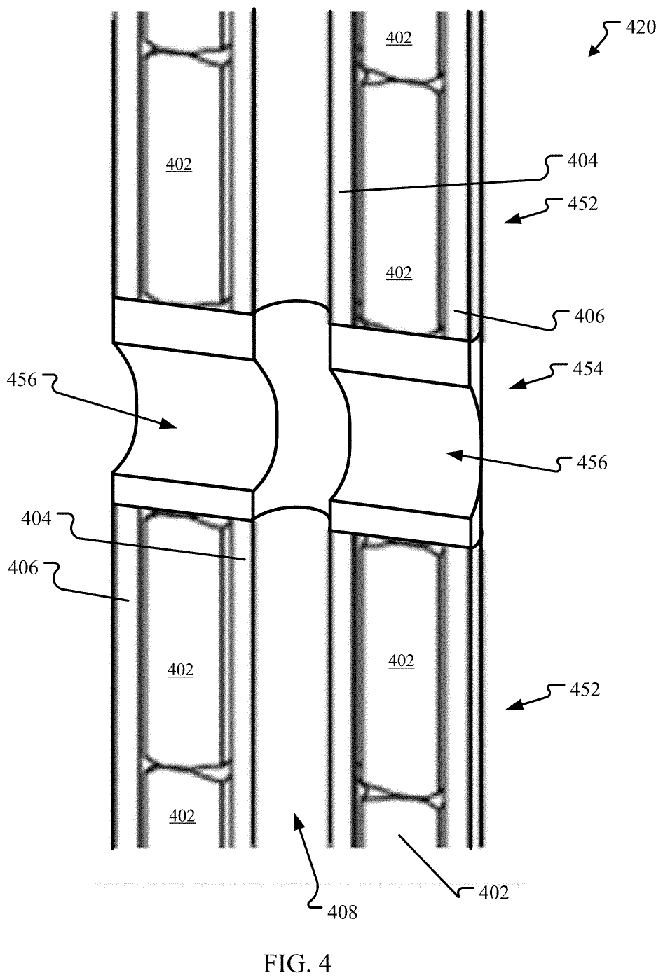

FIG. 4 illustrates a portion of an embodiment of a fuel rod of multiple segments including a connecting segment that allows for flow between the central region and the exterior of the fuel rod. The fuel rod 420 is of a similar design to that shown in FIGS. 1A and 1B. The annular metal fuel segments 452 contain one or more porous metal fuel slugs 402 contained within an inner cladding 404 and an outer cladding 406. End cap segments and one or more plenum segments (not shown) may be provided at either end of the fuel rod 420.

In the portion of the fuel rod 420 illustrated, the fuel rod 420 includes two annular fuel segments 452 connected by a connector segment 454. The connector segment 454 includes two chambers 456 connecting the central region 408 to the exterior of the fuel rod 420. Depending on the embodiment, more or fewer chambers may be used in the connector segment. The chambers 456 allow flow between the central region 408 and the exterior of a rod 420 to enhance the circulation of the coolant.

Annular metal fuel can be made out of porous metal nuclear fuel. Metal fuels include uranium, plutonium, uranium-zirconium (U—Zr) alloys, uranium-zirconium-niobium (U—Zr—Nb) alloys, uranium-plutonium-zirconium (U—Pu—Zr) alloys, uranium-plutonium-molybdenum (U—Pu—Mo) alloys, uranium-plutonium-niobium (U—Pu—Nb) alloys, uranium-plutonium-titanium (U—Pu—Ti) alloys, uranium-molybdenum (U—Mo) alloys, uranium-niobium (U—Nb) alloys, uranium-vanadium (U—V) alloys, uranium-chromium (U—Cr) alloys, and uranium-titanium (U—Ti) alloys. For the balance of this disclosure the embodiments of annular metal fuel will be presented in terms of U—Zr as the nuclear fuel. However, any metal nuclear fuel may be used in any of the embodiments described below. In an alternative embodiment, the fuel is not porous initially, but becomes porous during operation as the fuels swells during irradiation. While metal fuels do not include oxides such as uranium dioxide, in some embodiments an exterior surface of an annular fuel slug or metal fuel particle may have been exposed to oxygen resulting in trace amounts (less than 0.1% by weight) of oxides forming on the surface. For the purposes of this disclosure, the term “metal fuel” includes fuels with such trace amounts of oxides and is not limited to fuels having absolutely no measurable oxides.

Specifically with regards to metal fuels containing Zr (e.g., U—Zr and U—Pu—Zr), the percentage of Zr alloy can range from 1-20 wt. %, (e.g., 1 wt. %, 5 wt. %, 7.5 wt. %, 10 wt. %, 12.5 wt. %, 15 wt. % or 20 wt. % or any amount in between) and can be optimized for performance in PWR. Also, Zr fuel alloys are shown as an example and can be replaced or combined with one or more other alloy components (Cr, Ti, V, Ni, Nb, Al, Si, Mo). Such alloys may have better performance (i.e. reduced reactivity) when exposed to water. Also, doping additives could be added to the fuel to achieve desirable characteristics, in particular, resistance to reaction with water in case of cladding breach.

While traditional uranium oxide fuel rods' thermal performance is hindered by the existence of a helium filled gap between the fuel pellets and the cladding and the thermal conductivity of the uranium oxide pellets themselves, the metal fuel rods described herein are not so limited. Metal fuels undergo a larger amount of thermal expansion and have a higher thermal conductivity than traditional uranium oxide fuel pellets. Even though a clearance fit or gap may be necessary to allow a fuel slug to be inserted into the claddings, the metal alloys described above and U—Zr alloys in particular exhibit a larger thermal expansion than the cladding materials such that the gap will be eliminated at operational temperatures resulting in very good thermal contact between the fuel and the inner and outer claddings at operational temperatures. The high thermal conductivity of the fuel allows it to operate with significant unbonds, and because of the low creep strength of the fuel it is able to fill gaps. Annular fuel operates at much lower fuel temperatures than solid fuels. For UO₂ fuel peak fuel temperature is 2200° C. Peak fuel temperature for annular metal fuel is estimated to be from 400-500° C. if annular fuel is operated at 50% higher power than a UO₂-fueled reactors. In addition to a substantial reduction of the conduction length due to annular geometry, it is the elimination of the gap and higher internal thermal conductivity that allow annular metal fuel rods to operate at such low temperatures while still generating the same or more power than a UO₂-fueled reactor.

The low peak fuel temperature is another benefit of the annular metal fuel design over the traditional fuels. In addition, the lower heat capacity of metal fuel will further reduce stored energy and improve the loss of coolant accident (LOCA) performance of a reactor. Moreover, its benefit will improve the accident tolerability of the reactor core against the severe accident (SA) such as the station black out (SBO) during the Fukushima crisis. High thermal conductivity of the fuel will also support more rapid plant startup and increase the operational flexibility of the reactor to be used as load following power plants as described above.

As discussed above, the metal fuel may be an annular slug of metal fuel or may be in the form of fuel particles or fuel powder contained in the annular region defined by the inner cladding 104 and outer cladding 106. Metal fuel, even solid porous slugs, allows packing more heavy metal into the same volume than oxide fuel. This reduces required enrichment and reduces reactivity swing during the cycle and thus the required amount of burnable poison or boric acid in the coolant. The higher heavy metal packing also allows potential for use of different cladding materials beyond zirconium-based materials, which may have better high temperature performance or increased safety performance. Metal fuels also are more prone to release their fission gases to open space within the fuel rod, which can help reduce local stresses.

Particulate forms of fuel, such as fuel particles or fuel powder (powder defined as particles having a 0.5 mm diameter or less), may be packed into the annular region in order to achieve the desired porosity of the fuel. In one embodiment, the particulate may be vibration packed into the fuel rod to achieve a target bulk density and thereby achieve a corresponding target porosity.

Metal fuel powder may be manufactured in any suitable way. In addition, mixing of burnable poison materials such as gadolinium, boron, and erbium may improve reactor core economy. A small concentration of binding material such as zinc stearate or zinc behenate may be used to enhance compaction of fuel powder and prevent massive relocation of the fuel powder during shipping and handling. Other powder additives that may be suitable include lubricants (such as paraffin wax, stearates including aluminum, lithium, butyl, magnesium and sodium stearate, oleic acid, poly glycols, graphite and boron nitride) and other binders such as poly ethylene glycol.

A holddown device such as a solid ring or annular slug of zirconium or some other material that does not interact with uranium on the top of the powder stack may minimize the relocation of powder by providing compressive loads by gravity. The holddown device may be temporary for use only during shipping, handling, or storage and may be removed before use. One of potential benefits of the fuel powder is that the possibility of cladding failure by pellet-cladding-mechanical-interaction could be significantly lower than that of hard oxide pellet. Another is the low fabrication cost of vibration packing compared to the complicated sintering process of the oxide pellet.

The porosity, defined as the ratio of the void space volume to the total volume of the material, of the annular metal fuel may range from 0.1 to 0.5. This is an operational porosity that may be exhibited initially by the fuel or that may be achieved after a certain period of irradiation (e.g., after reaching the reactor's nominal operating temperature, after 1 hour at operating temperature, after 1 day, after 1 week, or even after 1 month). The porous nature of the metal fuel provides a benefit in resulting overall thermal conductivity of the fuel rod at operational temperatures over non-porous fuels with helium gaps between the fuel and cladding as the porous structure allows for thermal expansion without significantly affecting the structural integrity of the fuel while also causing a good thermal contact between the fuel and the claddings. The porosity also has another beneficial effect in that it provides void space for fission products to collect without causing the fuel to swell appreciably over time due to the ongoing fission.

The claddings used may be of any material, now known or later developed, suitable for use as a cladding with metal fuel. These may vary depending on the actual species of fuel used, but suitable claddings include stainless steels and ferritic martensitic steels such as those disclosed in Published U.S. Application No. 2017-0292179, titled HIGH TEMPERATURE RADIATION-RESISTANT, FERRITIC-MARTENSITIC STEELS, which application is incorporated by reference for the claddings it discloses. Claddings may also be duplex or triplex layers such as those described in Pending U.S. patent application Ser. No. 15/623,119, titled STEEL-VANADIUM ALLOY CLADDING FOR FUEL ELEMENT, which application is incorporated by reference for the claddings it discloses.

Zirconium alloys such as ZIRLO™ and zircalloy alloys may be used as cladding material. Alternatively, in some embodiments the annular metal fuels utilize claddings that contain no zirconium. When used with a PWR, this removes water-contacting zirconium from the core and, therefore, reduces the possibility of the zirconium-water reaction (with associated hydrogen generation which caused the explosion at the Fukushima crisis) from happening, which can occur as a runaway reaction at high temperatures.

Claddings may be separate components later combined with fuel to create fuel rods or may be co-extruded with or applied to the exterior of the metal fuel. In yet another embodiment, the claddings and/or or fuel may be created using an additive manufacturing process, either separately and then assembled or the cladding and fuel may be created in a single additive manufacturing process as a unitary component.

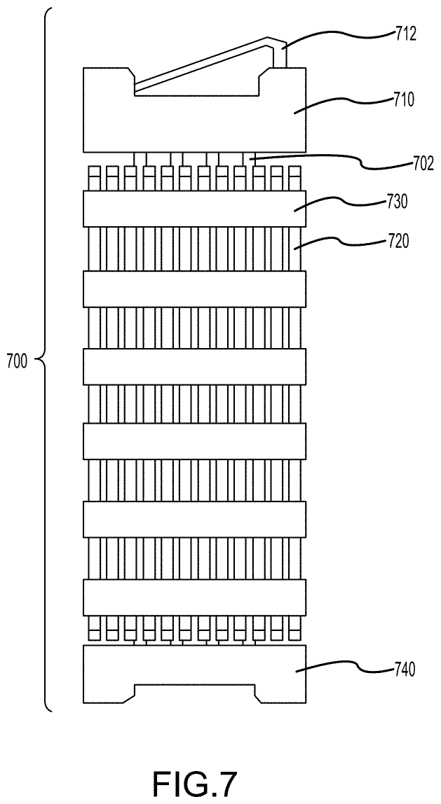

FIG. 7 illustrates a side view of a fuel assembly 700 for use in a pressurized water reactor. The assembly includes a set of fuel rods 720 penetrating and held in place by a number (six are shown) of spacer grids 730. A bottom nozzle assembly 740 supports the fuel assembly 700 within the core of the reactor. A top nozzle assembly 710 is provided at the top of the assembly 700 including a number of guide thimble tubes 702. The guide thimble tubes 702 extend from the top nozzle assembly 710 to the bottom nozzle assembly 740. The spacer grids 730 may be attached to the guide thimble tubes 702 for stability. A holddown spring 712 is provided above the top nozzle assembly 710 at the top of the assembly 700 to ensure the proper amount of holddown force on the fuel assembly's components.

It should be noted that the fuel rods described above need not be uniform along their length. For example regions of greater or lesser enrichment could be provided along the length of the fuel rod. This could be achieved by providing different annular slugs of fuel or different particulate fuel in the different regions during assembly. Likewise, specific regions could be provided with burnable poisons, other additives, or different types of metal fuels. In addition to different materials, different regions could be provided with different attributes such as different porosities, bulk densities, or different annular slug sizes even if the metal fuel material remains the same.

The fuel assemblies of FIGS. 3 and 7 are but two examples of a fuel assembly that could be retrofitted with embodiments of the annular metal fuel rods described above. Many other fuel assembly designs exist for use in other types of reactors. The arrangement of fuel rods and other types of rods (control rods, reflectors, and instrumentation rods, for example) within a particular assembly for a particular reactor may be modified as needed. The shape and arrangement of rods within an assembly as well as the shape, orientation, and arrangement of assemblies in a reactor core may differ as appropriate for the particular reactor design and as well as the number, type and performance of the annular metal fuel rods used.

### Annular Metal Fuel Rod Manufacturing Methods

The annular metal fuel rods described above may be manufactured by several different methods. Depending on the fuel type, the desired fuel porosity, and other user-selected criteria, certain methods may be more or less suitable.

One method is to manufacture the annular metal fuel and cladding as separate components and then assemble them into a fuel rod. In one embodiment of this method the fuel, the inner cladding and the outer cladding are each made separately and then assembled into one or more segments. If multiple segments are used to obtain the desired length, these segments are then assembled. After assembly, end caps are installed at both ends and the rod is ready for use. Other internal components such as a holddown device and/or a plenum spring may also be included and assembled at this time depending on the design. In an alternative embodiment of this method, the inner and outer claddings may be connected to an end cap and then one or more annuli of metal fuel may be inserted, then the rod may be sealed with the other end cap. Other orders of assembly are also possible. As described above, upon use in a reactor the metal fuel will expand, achieve its target porosity, and eliminate any gaps between the fuel and the claddings, thereby creating a fuel rod with good thermal conductance between the fuel and the claddings.

Three-dimensional (3D) printing or other additive manufacturing techniques may be used to generate one or more components, as mentioned above. In an embodiment, the fuel and claddings may be 3D printed as separate components or the outer cladding-fuel-inner cladding may be 3D printed as a single integrated intermediate component which is then capped to provide the final fuel rod.

A different method involves co-extrusion of at least two components of the fuel rod. For example, the inner cladding and the metal fuel may be co-extruded and then assembled with the outer cladding. Alternatively the outer cladding and the metal fuel may be co-extruded and then assembled with the inner cladding. In yet another embodiment, the three components (inner cladding, fuel and outer cladding) may be co-extruded simultaneously. rods created using the additive manufacturing and co-extrusion methods may or may not rely on the thermal expansion of the fuel to create a good thermal connection between the claddings and the fuel. For example, in an embodiment the manufacturing technique creates rods with metallurgical bonds between one or both claddings and the fuel. In these embodiments, the porosity is useful to relieve the stress that would otherwise be generated by the thermal expansion of the fuel at operational temperatures reducing the requirements on the cladding strength.

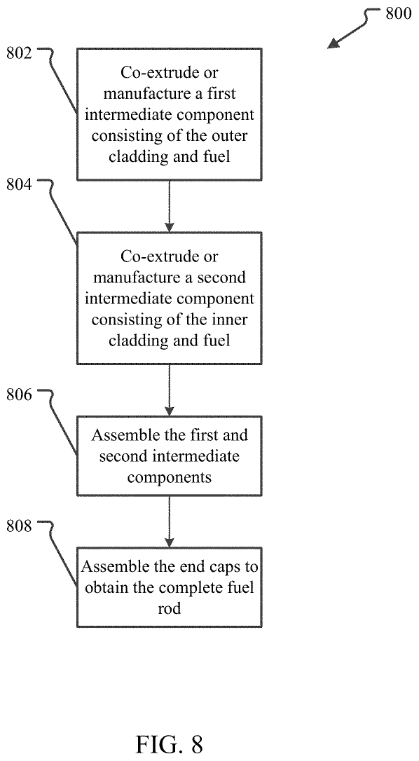

A variation on the co-extrusion method is a dual intermediate component manufacture method. This variation is illustrated in FIG. 8. In this variation 800, the outer cladding with an annulus of fuel on the interior of the outer cladding is created 802, for example by assembly, co-extrusion as one piece, additive manufacturing as one piece, or by deposition of one material (i.e., cladding material or fuel) onto a piece of the other. Separately, the inner cladding with an annulus of fuel on the outer surface of the inner cladding is created 804 as a second piece. These two intermediate components are then assembled 806 and capped 808 to obtain the completed fuel rod.

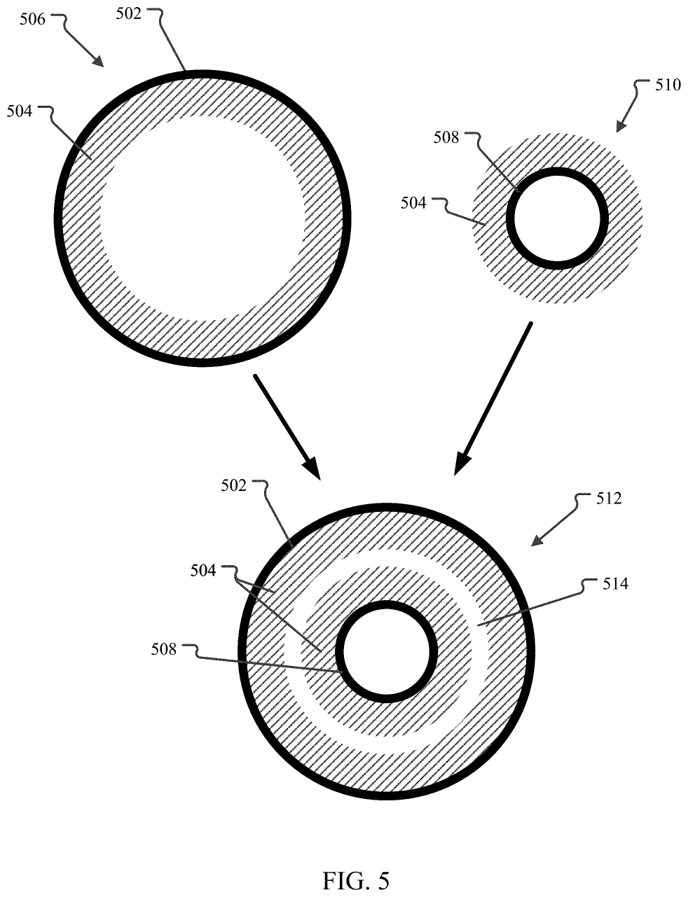

FIG. 5 illustrates the intermediate components of the dual intermediate component manufacture method described above. The outer cladding 502 and at least some metal fuel 504 are co-extruded or otherwise made as a first intermediate component 506. The inner cladding 508 and at least some metal fuel 504 are created as a second intermediate component 510. The two intermediate components 506, 510 are then assembled into a third intermediate component 512 that is ready for capping. The inner diameter of the first intermediate component 506 and the outer diameter of the second intermediate component 510 may be tailored to allow for an easy slip fit (e.g., about 0.01-1 mm or about 0.05-0.1 mm between the inner diameter of the first intermediate component 506 and the outer diameter of the second intermediate component 510) or may be further increased to create a larger gap 514 between the two fuel annuli.

The fuel rods produced by the dual intermediate component co-extrusion method are anticipated to have better performance than those created by some of the other methods described above. The dual intermediate component method, especially when using co-extrusion, creates a closer bond and better contact surface between the fuel and the claddings than achieved with simple assembly methods. This improves the thermal conductance between the fuel and the claddings relative to the other manufacturing methods. It further provides a space (i.e., the gap 514 between the two fuel surfaces of the intermediate components 506, 510) for thermal expansion of the fuel that does not negatively impact the thermal conductance between the fuel and either cladding 502, 508. The porous nature of the metal fuel provides additional benefit by allowing space for fission products to collect.

Yet another manufacturing method is applicable when manufacturing annular metal fuel rods from metal fuel particulate such as U—Zr powder. In this method, the inner and outer claddings are assembled together and then the fuel powder is introduced in the region between the two claddings. The fuel powder may then be packed either through vibration packing or traditional ramming techniques to obtain the desired bulk density and porosity within the fuel. An end cap or caps may then be applied to create the completed fuel rod. Vibration packing may include subjecting the powder within the claddings to vibrations with a selected stroke at a selected frequency for a selected period of time. In one embodiment, the vibration stroke, frequency and time are predetermined to achieve the desired porosity. In an alternative embodiment, the porosity and/or bulk density of powder is monitored and one or more of the vibration stroke, frequency and time are varied until the desired target value(s) are achieved. As mentioned above, a holddown device such as bar, ring, or tube of zirconium or other unreactive metal or material can provide additional compacting forces during the packing process and can minimize the risk of massive relocation of the powder during shipping and handling.

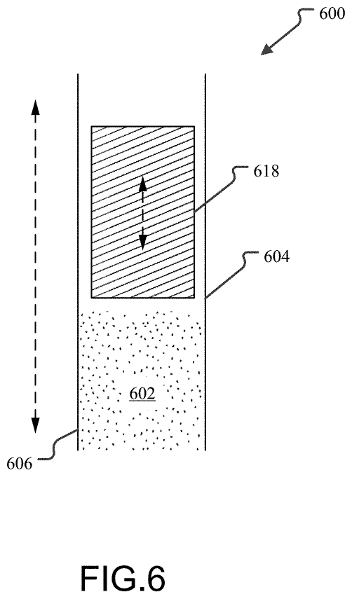

FIG. 6 illustrates a cross section of a portion of an annular space between the claddings showing the fuel and holddown device. In FIG. 6, the holddown device 618 is an annulus of Zr sized to fit within the inner cladding 604 and outer cladding 606. The holddown device 618 either rests or is repeatedly driven against the fuel powder 602 in the annulus space. The fuel rod 600 may also be vibrated as described above.

Furthermore, the holddown device 618 may be a screen, porous annular slug, or other device designed to allow gas flow through or around the device allowing fission products to be released from the fuel into a plenum region within the fuel rod, e.g., at the end caps for example.

In addition to those described above, further embodiments are disclosed in the following numbered clauses:

1. A nuclear fuel rod comprising:

an outer cladding;

an inner cladding within the outer cladding, the inner cladding defining a coolant channel;

and a metal fuel between the outer cladding and the inner cladding.

2. The nuclear fuel rod of clause 1, wherein the metal fuel has a porosity from 0.1 to 0.5.
3. The nuclear fuel rod of clause 1 or 2, wherein the metal fuel is selected from uranium, plutonium, a mixture of uranium and plutonium, an alloy of uranium, an alloy of plutonium, or an alloy of uranium and plutonium.
4. The nuclear fuel rod of clause 1, wherein the metal fuel is selected from uranium, plutonium, an alloy of uranium or an alloy of plutonium and has a porosity from 0.1 to 0.5.
5. The nuclear fuel rod of any of clauses 1-4, wherein the coolant channel extends the length of the fuel rod.
6. The nuclear fuel rod of any of clauses 1-5 further comprising:

an end cap at each end of the fuel rod such that the metal fuel is retained within the fuel rod.

7. The nuclear fuel rod of any of clauses 1-6 further comprising:

at least one biasing element between the outer cladding and the inner cladding that applies a bias force on the porous metal fuel.

8. The nuclear fuel rod of any of clauses 1-7, wherein the metal fuel includes at least one annulus of solid metal fuel between the inner cladding and the outer cladding.
9. The nuclear fuel rod of any of clauses 1-8, wherein the metal fuel achieves the porosity of from 0.1 to 0.5 after one month of irradiation.
10. The nuclear fuel rod of any of clauses 1-9, wherein the metal fuel is a quantity of metal fuel powder packed into a space between the inner cladding and the outer cladding.
11. The nuclear fuel rod of any of clauses 1-10, wherein the metal fuel is selected from a U—Zr alloy, a U—Zr—Nb alloy, a U—Pu—Zr alloy, a U—Pu—Mo alloy, a U—Pu—Nb alloy, and a U—Pu—Ti alloy.
12. The nuclear fuel rod of any of clauses 1-11, wherein the metal fuel is an alloy of uranium and one or more of Cr, Ti, V, Ni, Nb, Al, Si, and Mo.
13. The nuclear fuel rod of any of clauses 1-12, wherein the outer cladding has a cross-sectional shape selected from square, circle, rectangular, hexagonal, octagonal, polygonal, and lobed.
14. The nuclear fuel rod of any of clauses 1-13, wherein an exterior surface of the nuclear fuel rod has a helical twist along its length.
15. The nuclear fuel rod of any of clauses 1-14, wherein the coolant channel has a cross-sectional shape selected from square, circle, rectangular, hexagonal, octagonal, polygonal, and lobed.
16. The nuclear fuel rod of any of clauses 1-15, wherein the coolant channel is provided with an internal structure.
17. The nuclear fuel rod of any of clauses 1-16, wherein the coolant channel is provided with an internal structure that is helically twisted along the length of the rod.
18. The nuclear fuel rod of any of clauses 1-17, wherein at least one of the inner cladding and outer cladding is made of steel.
19. The nuclear fuel rod of any of clauses 1-18, wherein at least one of the inner cladding and the outer cladding is made of zirconium or a zirconium alloy.
20. The nuclear fuel rod of any of clauses 1-19, wherein at least one liner is provided between the inner cladding and the metal fuel or the outer cladding and the metal fuel or both.
21. A nuclear fuel assembly for use in a pressurized water reactor (PWR) comprising:

a frame shaped and configured to a core of the PWR; and

a plurality of fuel rods within the frame;

wherein at least one of the plurality of fuel rods is a fuel rod of clause 1.

22. The nuclear fuel assembly of clause 21 wherein the at least one of the plurality of fuel rods is a fuel rod of at least one of clauses 2-20.
23. A pressurized water reactor (PWR) containing at least one nuclear fuel rod assembly of clause 21 or 22.
24. A method for manufacturing an annular nuclear fuel rod comprising:

creating a first intermediate component, the first intermediate component including an outer cladding tube having an interior surface and an exterior surface and having a first layer of metal fuel on the interior surface;

creating a second intermediate component, the second intermediate component including an inner cladding tube having an interior surface and an exterior surface and having a second layer of metal fuel on the exterior surface; and assembling the first intermediate component with the second intermediate component to obtain the annular nuclear fuel rod.

25. The method of clause 24, further comprising:

capping the nuclear fuel rod on at least one end of the nuclear fuel rod.

26. The method of clause 24 or 25, wherein creating the first intermediate component further comprises:

co-extruding outer cladding material and metal fuel together to create the first intermediate component.

27. The method of any of clauses 24-26, wherein creating the first intermediate component further comprises:

depositing the outer cladding material on porous metal fuel or the metal fuel onto the outer cladding tube to create the first intermediate component.

28. The method of any of clauses 24-27, wherein creating the second intermediate component further comprises:

co-extruding inner cladding material and metal fuel together to create the second intermediate component.

29. The method of any of clauses 24-28, wherein creating the second intermediate component further comprises:

depositing the inner cladding material on metal fuel or the metal fuel onto the inner cladding tube to create the second intermediate component.

30. The method of any of clauses 24-29, wherein the metal fuel achieves a porosity of from 0.1-0.5 only after irradiation.
31. The method of any of clauses 24-30, wherein at least one of the first layer of metal fuel and the second layer of metal fuel has an initial porosity of from 0.1-0.5.
32. A method for manufacturing an annular nuclear fuel rod comprising:

creating a first intermediate component, the first intermediate component including an inner cladding tube within an outer cladding tube defining an annular space between the inner cladding tube and the outer cladding tube;

placing a powder of metal fuel in the annular space between the inner and outer cladding tubes;

packing the powder of metal fuel in the annular space between the inner and outer cladding tubes until a target porosity in the metal fuel is achieved; and

capping the packed powder within the annular space between the inner and outer cladding tubes.

33. The method of clause 32, wherein packing the powder of metal fuel further comprises: includes vibrating the powder for a period of time at a selected frequency.
34. The method of clause 32 or 33, wherein vibrating the powder metal fuel further comprises:

subjecting the powder to a predetermined vibration stroke at a predetermined frequency for a predetermined period of time.

35. The method of any of clauses 32-34, wherein packing the powder of metal fuel further comprises:

monitoring the porosity and/or bulk density of the powder while packing the powder.

36. The method of any of clauses 32-35, wherein vibrating the powder metal fuel further comprises:

varying one or more of the vibration stroke, frequency, and time until the desired target porosity is achieved.

37. A method for manufacturing an annular nuclear fuel rod of any one of clauses 1-20 comprising:

creating a first intermediate component, the first intermediate component including an outer cladding tube having an interior surface and an exterior surface and having a first layer of metal fuel on the interior surface;

creating a second intermediate component, the second intermediate component including an inner cladding tube having an interior surface and an exterior surface and having a second layer of metal fuel on the exterior surface; and

assembling the first intermediate component with the second intermediate component to obtain the annular nuclear fuel rod.

38. The method of clause 37, further comprising:

capping the nuclear fuel rod on at least one end of the nuclear fuel rod.

39. The method of clause 37 or 38, wherein creating the first intermediate component further comprises:

co-extruding the outer cladding tube and metal fuel.

40. The method of any of clauses 37-39, wherein creating the first intermediate component further comprises:

depositing outer cladding material on porous metal fuel or depositing the metal fuel onto the outer cladding tube.

41. The method of any of clauses 37-40, wherein creating the second intermediate component further comprises:

co-extruding inner cladding material and metal fuel.

42. The method of any of clauses 37-41, wherein creating the second intermediate component further comprises:

depositing inner cladding material on metal fuel or depositing the metal fuel onto the inner cladding tube.

43. The method of any of clauses 37-42, wherein the metal fuel achieves a porosity of from 0.1-0.5 only after irradiation.
44. The method of any of clauses 37-43, wherein at least one of the first layer of metal fuel and the second layer of metal fuel has an initial porosity of from 0.1-0.5.
45. A method for manufacturing an annular nuclear fuel rod of any one of clauses 1-20 comprising:

creating a first intermediate component, the first intermediate component including an inner cladding tube within an outer cladding tube defining an annular space between the inner cladding tube and the outer cladding tube;

placing a metal fuel powder in the annular space between the inner and outer cladding tubes;

packing the metal fuel powder in the annular space between the inner and outer cladding tubes until a target porosity in the metal fuel is achieved; and

capping the packed metal fuel powder within the annular space between the inner and outer cladding tubes.

46. The method of clause 45, wherein packing the metal fuel powder further comprises:

vibrating the metal fuel powder for a period of time at a selected frequency.

47. The method of clause 45 or 46, wherein vibrating the metal fuel powder further comprises:

subjecting the metal fuel powder to a predetermined vibration stroke at a predetermined frequency for a predetermined period of time.

48. The method of any of clauses 45-47, wherein packing the metal fuel powder further comprises:
monitoring the porosity and/or bulk density of the metal fuel powder while packing the metal fuel powder.
   49. The method of any of clauses 45-48, wherein vibrating the metal fuel powder further comprises:

varying one or more of the vibration stroke, frequency, and time until the desired target porosity is achieved.

It will be clear that the systems and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

What is claimed is:

1. A nuclear fuel rod comprising:
an outer cladding;
an inner cladding within the outer cladding, the inner cladding defining a coolant channel; and
a metal fuel between the outer cladding and the inner cladding.

2. The nuclear fuel rod of claim 1, wherein the metal fuel has a porosity from 0.1 to 0.5.

3. The nuclear fuel rod of claim 1, wherein the metal fuel is selected from uranium, plutonium, a mixture of uranium and plutonium, an alloy of uranium, an alloy of plutonium, or an alloy of uranium and plutonium.

4. The nuclear fuel rod of claim 1, wherein the metal fuel is selected from uranium, plutonium, an alloy of uranium or an alloy of plutonium and has a porosity from 0.1 to 0.5.

5. The nuclear fuel rod of claim 1, wherein the coolant channel extends a length of the fuel rod.

6. The nuclear fuel rod of claim 1 further comprising:
an end cap at each end of the fuel rod such that the metal fuel is retained within the fuel rod.

7. The nuclear fuel rod of claim 1 further comprising:
at least one biasing element between the outer cladding and the inner cladding that applies a bias force on the porous metal fuel.

8. The nuclear fuel rod of claim 1, wherein the metal fuel includes at least one annulus of solid metal fuel between the inner cladding and the outer cladding.

9. The nuclear fuel rod of claim 1, wherein the metal fuel achieves the porosity of from 0.1 to 0.5 after one month of irradiation.

10. The nuclear fuel rod of claim 1, wherein the metal fuel is a quantity of metal fuel powder packed into a space between the inner cladding and the outer cladding.

11. The nuclear fuel rod of claim 1, wherein the metal fuel is selected from a U—Zr alloy, a U—Zr—Nb alloy, a U—Pu—Zr alloy, a U—Pu—Mo alloy, a U—Pu—Nb alloy, and a U—Pu—Ti alloy.

12. The nuclear fuel rod of claim 1, wherein the metal fuel is an alloy of uranium and one or more of Cr, Ti, V, Ni, Nb, Al, Si, and Mo.

13. The nuclear fuel rod of claim 1, wherein the outer cladding has a cross-sectional shape selected from square, circle, rectangular, hexagonal, octagonal, polygonal, and lobed.

14. The nuclear fuel rod of claim 1, wherein an exterior surface of the nuclear fuel rod has a helical twist along its length.

15. The nuclear fuel rod of claim 1, wherein the coolant channel has a cross-sectional shape selected from square, circle, rectangular, hexagonal, octagonal, polygonal, and lobed.

16. The nuclear fuel rod of claim 1, wherein the coolant channel is provided with the internal structure helically twisted along the length of the nuclear fuel rod.

17. The nuclear fuel rod of claim 1, wherein at least one of the inner cladding and outer cladding is made of steel, zirconium or a zirconium alloy.

18. A nuclear fuel assembly for use in a pressurized water reactor (PWR) comprising:
a frame shaped and configured to a core of the PWR; and
a plurality of fuel rods within the frame;
wherein at least one of the plurality of fuel rods is a fuel rod of claim 1.

19. A method for manufacturing an annular nuclear fuel rod comprising:
creating a first intermediate component, the first intermediate component including an outer cladding tube having an interior surface and an exterior surface and having a first layer of a metal fuel on the interior surface;
creating a second intermediate component, the second intermediate component including an inner cladding tube having an interior surface and an exterior surface and having a second layer of a metal fuel on the exterior surface; and
assembling the first intermediate component with the second intermediate component to obtain the annular nuclear fuel rod.

20. A method for manufacturing an annular nuclear fuel rod comprising:
creating a first intermediate component, the first intermediate component including an inner cladding tube within an outer cladding tube defining an annular space between the inner cladding tube and the outer cladding tube;
placing a metal fuel powder in the annular space between the inner and outer cladding tubes;
packing the metal fuel powder in the annular space between the inner and outer cladding tubes until a target porosity in the metal fuel powder is achieved; and
capping the packed metal fuel powder within the annular space between the inner and outer cladding tubes.
